(19) United States
(12) Patent Application Publication
(10) Pub. No.: US 2015/0220253 A1
(43) Pub. Date: Aug. 6, 2015

(54) VARYING TRANSLUCENCY OF A GRAPHIC IMAGE OF AN E-BOOK TO INDICATE READING PROGRESS

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/169,966

(22) Filed: Jan. 31, 2014

(51) Int. Cl. G06F 3/0484; G06F 15/02

(52) U.S. Cl. CPC G06F 3/04845; G06F 15/0291

(57) ABSTRACT

A computing device to vary a translucency of a graphic representation of an e-book (e.g., iconic digital book cover) to reflect an activity or status, such as a user's progress in reading the e-book.

### TECHNICAL FIELD

Examples described herein include a system and method for varying a translucency of a graphic image of an e-book to indicate a user's progress in reading the e-book.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to enhance electronic reading activity, according to an embodiment.

FIG. 2 illustrates an example of an e-reader device or other electronic personal display device, for use with one or more embodiments described herein.

FIG. 3 illustrates an example device system for providing translucency in the context of displaying collections of e-books, according to an embodiment.

FIG. 4 illustrates a method for displaying translucency with graphic representations of e-books, according to one or more embodiments.

FIG. 5A illustrates an example of a library presentation that implements translucency with the graphic representation of one or more e-books, in order to convey a user's progress level user in reading the corresponding e-book.

FIG. 5B illustrates an alternative panel view 530 for displaying the contents of the user's e-book collection.

FIG. 5C illustrates an alternative list view for displaying the contents of the user's e-book collection.

FIG. 5D illustrates an alternative implementation in which a discrete portion of the graphic representation of an e-book is made translucent to reflect the progress of the user in reading the e-book.

### DETAILED DESCRIPTION

Embodiments described herein provide for a computing device that varies a translucency level of a graphic representation of a content item (e.g., iconic digital cover for e-book) to reflect an activity or status. By way of example, an embodiment includes a computing device that varies a translucency level of a graphic representation of an e-book in order to reflect a user's progress towards completing the corresponding e-book.

According to examples described herein, a set of graphic representations are displayed in the context of a computing device, such as an e-reader device. Each of the graphic representations can include images and/or other content that is associated with an e-book in a collection of e-books of the user. A user's progress in reading a first e-book in the collection is detected, where the first e-book is represented by a first graphic representation. A translucency of the first graphic representation is varied based on the detected progress of the user in reading that e-book.

Among other benefits, examples described herein convey status or activity information for content items such as e-books using translucency. By way of comparison, some conventional approaches utilize text (e.g., text indicating how much progress the user has made in reading a particular e-book) or independent iconic images (e.g., completion bars) which occupy real-estate on an otherwise compact screen. In contrast to such conventional approaches, some embodiments described herein provide for altering the translucency of a graphic representation of an e-book to reflect the user's progress in completing the e-book.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

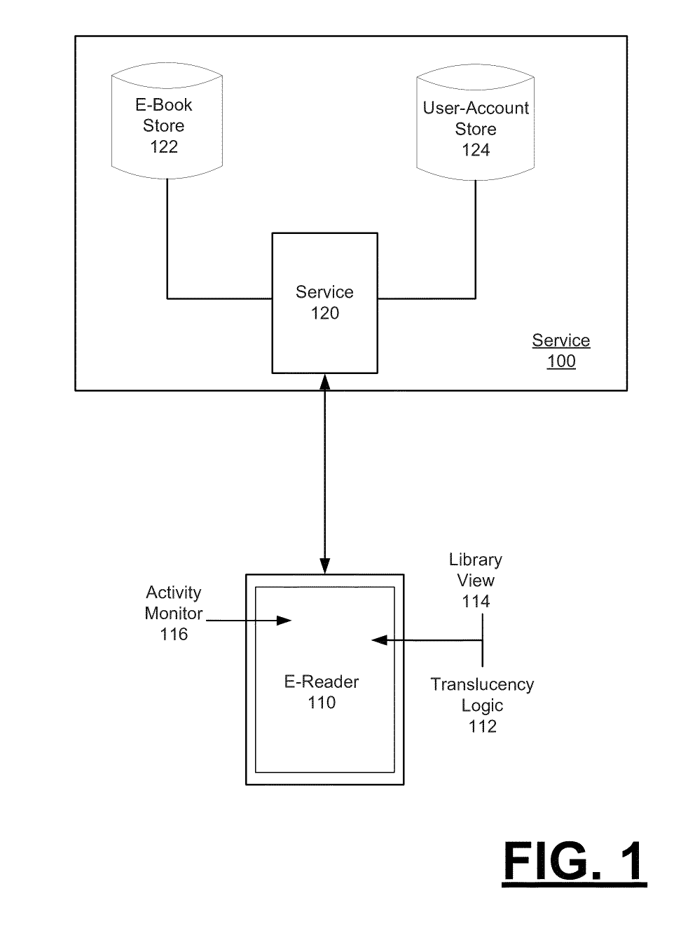

FIG. 1 illustrates a system for operating a computing device to enhance electronic reading activity, according to an embodiment. In an example of FIG. 1, system 100 includes an electronic display device, shown by way of example as an e-reader device 110, and a network service 120. The network service 120 may include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). For example, the e-reader device 110 can have a tablet like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With further reference to FIG. 1, the library view logic 114 can execute to display a collection of digital content items belonging to a user (e.g., digital content items that the user has purchased for download, licensed, or otherwise obtained a right of possession). The library view logic 114 operates to display graphic representations of individual content items. For example, library view logic 114 can display iconic representations of album covers, movie titles and television shows. In the context of e-books, library view logic 114 can display icons representing book covers or jackets, magazine covers, comic book covers, etc. The library view logic 114 can provide multiple organizational structures for displaying graphic representations of content items, including structures such as lists, folders, or virtual structures such as bookshelves (for e-books).

The e-reader device 110 can include translucency logic 112 which executes to after a translucency level of the graphic representations of various content items. The translucency logic 112 can adjust the translucency level of the graphic representations based on a status or activity level for that item. In the context of e-books, the e-reader device 110 can implement an activity monitor 116 that tracks a user's progress when reading a particular e-book. The activity monitor 116 can, for example, determine what percentage or portion of the e-book the user has completed, based on, for example, monitoring, page turning events, and/or pages that the user completes when operating the e-reader device 110. The activity monitor can further determine information such as how much of an e-book the user has read, how long it has taken the user to complete the portion of the e-book, and/or how much time is needed before the user completes the e-book.

According to some embodiments, the translucency logic 112 can correlate a metric, such as the proportion of the e-book that the user has yet to complete, into a translucency level for displaying the graphic representation of the particular e-book that the user is reading. In one embodiment, the translucency setting can range between a minimum value (e.g., no translucency) and maximum value (e.g., 85% translucency), and the translucency level of the graphic representation for the e-book can range from the maximum level (when the user initiates reading the e-book) to a minimum level (when the user completes, or substantially completes the e-book). In this way, the translucency level or characteristic of the graphic representation (e.g., iconic book cover) can qualitatively convey to the user how much of an e-book the user has read.

In variations, the translucency level can be determined from other metrics, such as an estimated time to completion (e.g., the number of hours the user has remaining until the e-book is complete). While an example of FIG. 1 is specific to e-books, in variations, translucency can substitute for qualitatively conveying information about the status or activity level of other kinds of content items. For example, in the context of movies, translucency logic 112 can affect the graphic representation of the movie item (e.g., movie poster icon) in order to convey whether the user has viewed the entire movie or portion thereof.

Hardware Description

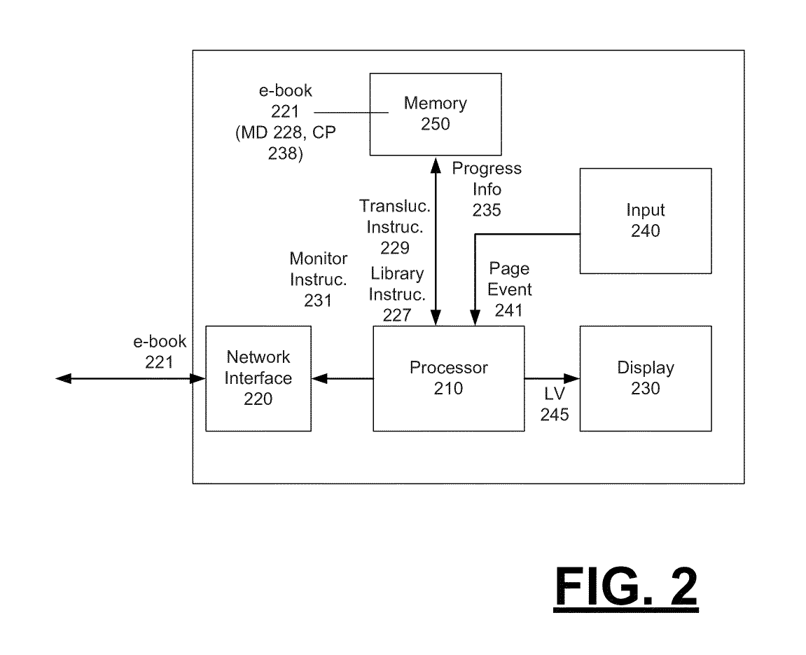

FIG. 2 illustrates an example of an e-reader device or other electronic personal display device, for use with one or more embodiments described herein. In an example of FIG. 2, an e-reader device 200 can correspond to, for example, a device such as also shown by e-reader device 110 of an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices).

With further reference to FIG. 2, the memory 250 can retain instructions 227 for implementing library view logic 114 (see FIG. 1) and instructions 229 for implementing translucency logic 112 (see FIG. 1). The memory resources 250 can also retain instructions 231 for implementing the activity monitor 116 (see FIG. 1). Application resources such as e-books 221 can be received by the network interface 220 from, for example, network service 120 and stored in the memory 250. Each e-book can be associated with a record 226 that includes a metadata set 228 and a content portion 238. The metadata set 228 can include, for example, the graphic representation of the e-book, such as an iconic representation of a book cover, as well as summary information (author, title, short synapse). In one implementation, the processor 210 executes instructions 231 for implementing the activity monitor 116 to generate metadata corresponding to progress information 235 that quantifies the user's progress towards completing a particular e-book. The instructions 231 for implementing the activity monitor 116 can use as input, for example, page events 241 generated by user interaction with the input mechanism 240 and/or display 230 (e.g., touchscreen input).

The processor 210 also executes instructions 229 for implementing the translucency logic 112 in order to vary the translucency of select metadata associated with the e-book that is being read. In particular, the processor 210 operates to vary the translucency of the graphic representation (e.g., book cover icon) of the e-book being read. The graphic representation of the e-book can have its translucency varied when it is displayed in the context of a collection of e-books. The processor 210 can also execute instructions for implementing library view logic 227, so that select graphic representations provided through the library view logic 114 can have a varying translucency setting to express the progress of the user in completing the particular e-book. The instructions 229 for implementing the translucency logic 112 can use progress information 235 as input in order to determine the translucency setting for rendering the graphic representation of the e-book that is being read.

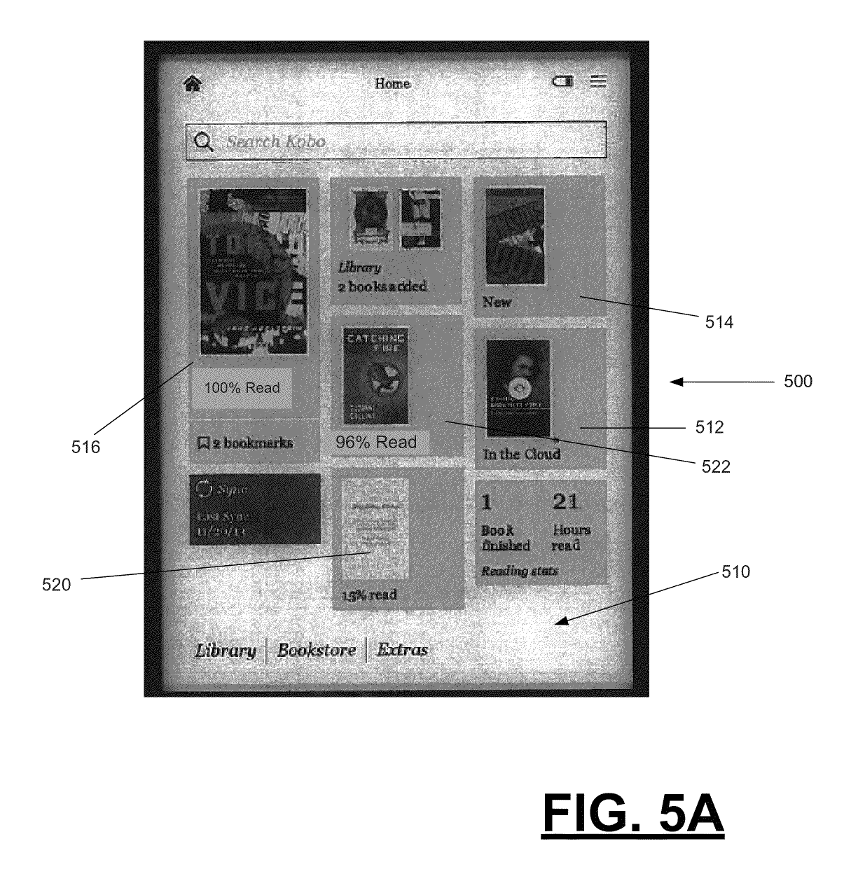

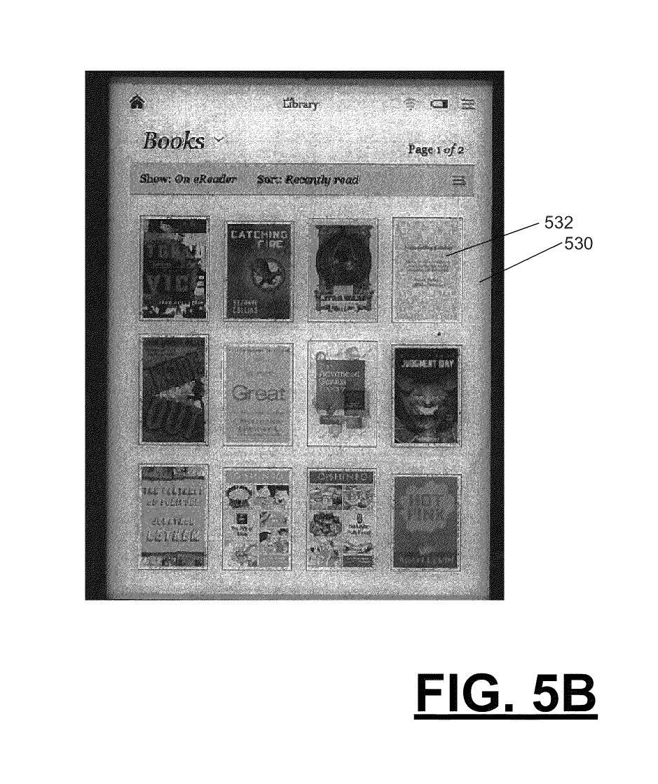

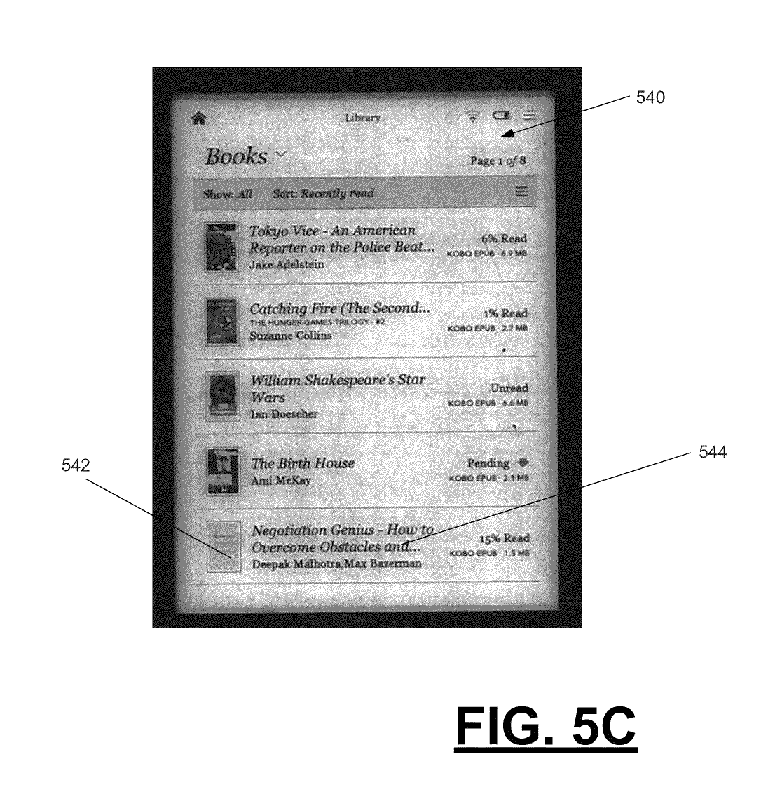

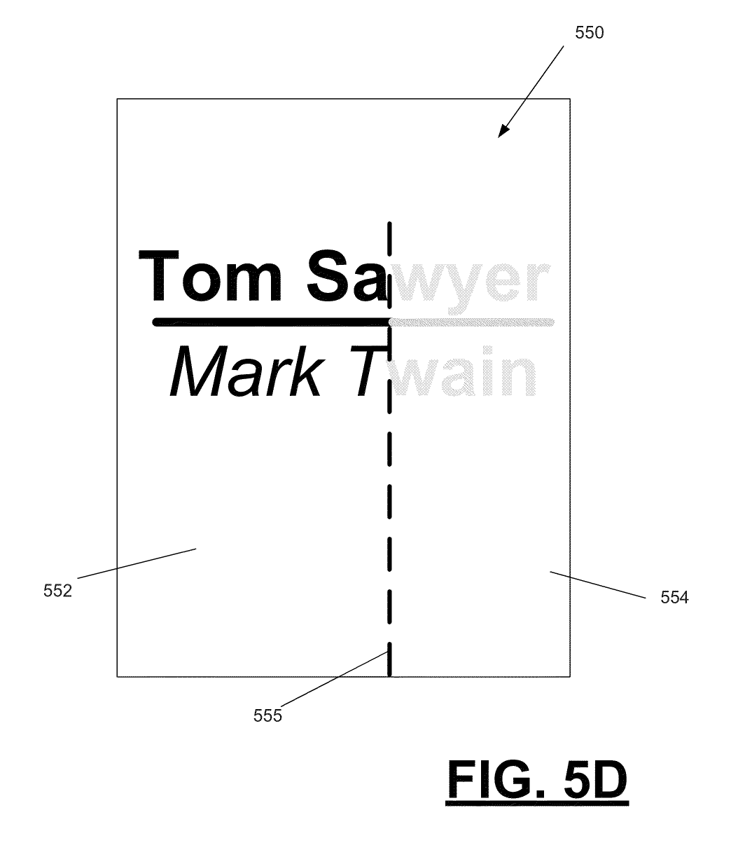

The processor 210 can generate a library view 245 for the display 230. The library view 245 can include graphic representations of different e-books, with one or more of the graphic representations being partially translucent to reflect a status or activity level of the corresponding e-book. In this way, the translucency level of the individual graphic representations can vary, particularly for e-books that are currently in a status of being read by the user. As illustrated by examples of FIG. 5A through FIG. 5C, the translucency level of individual graphic representations can vary to express the users progress towards completing the e-book.

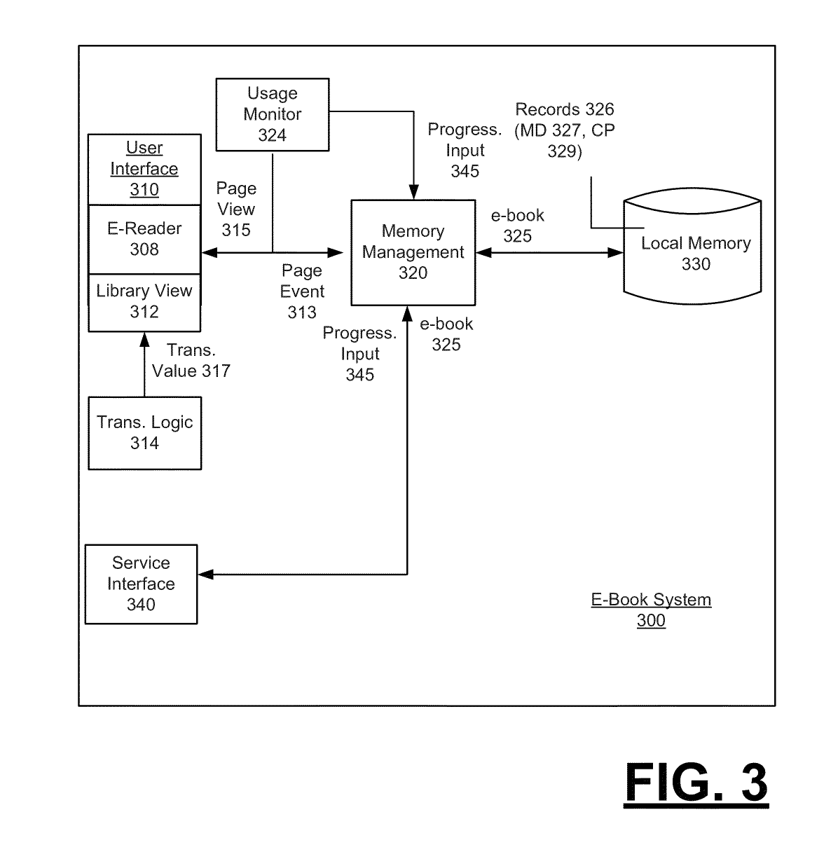

FIG. 3 illustrates an example device system for providing translucency in the context of displaying collections of e-books, according to an embodiment. In reference to FIG. 3, a system 300 implements programmatic components for communicating with an e-book service (such as network service 120, shown in FIG. 1), as well as for enabling functionality for viewing and accessing e-books utilized by an account associated with the e-reader device 110 (see FIG. 1 or FIG. 2). In some embodiments, the system 300 can be implemented as an application that runs on an e-reader device, such as shown with examples of FIG. 1 or FIG. 2.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection, to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books 325 from the network service 120. For example, in identifying the e-reader device 110 of system 300 to the network service 120, the network service may be able to procure payment information (e.g., stored credit card information) that can be used to charge the user's account when the user purchases a new e-book from the service. Each e-book can correspond to a literary work having a pagination format. Optionally, some e-books may have chapter designations, as well as content that corresponds to graphics or images (e.g., such as in the case of magazines or comic books). Individual e-books 325 can also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. Alternatively, as another example, network service 120 can be configured to push e-books to the e-reader device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reader device 110, as well as updates to lists, download of e-books that the user may have purchased on another device of the same account, recommendations from the network as to what a given user may want to purchase or view, and/or various other data that can be either generally provided to the user of the network service or specifically provided for the particular account or user.

According to some embodiments, the local memory 330 stores each e-book as a record 326 that includes metadata 327 and content 329 (e.g., page content). The memory management module 320 can retrieve portions of individual e-books for purpose of rendering e-books via the user interface 310.

In an example of FIG. 3, the user interface 310 of system 300 includes an e-reader component 308, a library view component 312, and a translucency component 314. The e-reader component 308 operates to display content, corresponding to, for example, paginated content from an e-book. The e-reader component 308 can also permit interaction from the user, such as prompts or features for enabling the user to enter page events 313. Each page event 313 can correspond to the user transitioning from one page to the next, or from one page by cluster to another page, or from one chapter to another chapter. The e-reader component 308 can detect and respond to input that corresponds to page events 313. The memory management module 320 can receive page event 313, and update the paginated content 315 for the e-reader component 308 based on the page event 313, as well as the sequential structure of the content portion 329 of the e-book.

A usage monitor 324 can be provided to track the user's progression in reading a particular e-book 325. The usage monitor 324 can record activity coinciding with a location (e.g., page number) of the e-book that is displayed when the user completes a reading session. In this way, the usage monitor 324 can track each page that the user completes, and records the one that the user is on when a reading session is terminated. The recorded input can correspond to progression input 345 (e.g., the user closes the e-book, returns the menu, and/or terms of device off). The usage monitor 324 can communicate progression input 345 to the memory management module 320.

In some variations, the progression input 345 as determined by the usage monitor 324 can be communicated to the network service 120 via the service interface 340. In such an implementation, the memory management module 320 is able to receive progression input 345 from the network service 120, to enable functionality such as enabling the user to synchronize the current page or position of an e-book that is being read by the user on multiple devices. For example, the user may operate a first device to read a particular e-book, then use the e-reader device 110 of the system 300 to continue reading the e-book. When the user operates the e-reader device 110 to open the e-book, the service interface 340 signals the account and the identifier for the particular e-book to the network service 120. The network service 120 provides the e-book system 300 with progression input 345 based on activity performed on another device. In this way, the memory management module 320 can use the progression input 345 to synchronize the position of the e-book to the last page the user read on another device (rather than assume the last position is the one that the user read on the local e-reader device 110). In one implementation, updated progression input 345 can be stored with the record 326 for the particular e-book.

The library view component 312 can display graphic representations and other information for individual e-books in the user's collection. For example, the library view component 312 can use the metadata 327 associated with the records 326 of the e-books in the user's account to display lists, folders, or other virtual structures that include graphic representations and/or other identifiers of e-books in the user's collection. The user's collection can include e-books that the user has on the particular device (e.g., locally stored e-books), as well as e-books that may not be locally stored, but are associated with the user account (e.g., read on another device, archived, etc.). In one implementation, the local memory 330 can include records 326 for each e-book in the user's account, and each record 326 can include its metadata 327. The user may have the content portion of select e-books archived, so as to not reside in the memory 330, but be provided by the network service 120 as requested or needed. By way of example, the library view component 312 can display the e-books of a user's collection using a virtual book shelf or bookcase feature on which graphic representations of e-books (e.g., images of book cover jackets) are rendered. In such an implementation, the e-books are displayed as icons that include imagery, title information etc. In a variation, the library view component 312 can display representations of e-books in the user's collection as icons, or as icons with associated text. Still further, folders can be used to provide a panel view of the graphic representations (e.g. icons and/or text) of the e-books in the user's collection.

The translucency component 314 can receive data corresponding to progression input 345 for each e-book in the user's collection. For example, the translucency component 314 can communicate or otherwise access local memory 330 in order to obtain the progress of the user with respect to each e-book in the user's collection. The translucency component 314 can then generate a translucency input 317 for the library view component 312. The translucency input 317 can (i) identify the e-book, and (ii) provide a translucency level for the e-book. The translucency level selected for the e-book can be based on design and implementation. In one embodiment, translucency component 314 generates a translucency value 317 that ranges between a maximum (e.g., 80% or 85% translucent) and minimum value (e.g., 0% translucent). The translucency value 317 that is outputted from the translucency component 314 can be one of the maximum value, minimum value, or value between the maximum and minimum value. The translucency values 317 between the maximum and minimum values can be discretely defined and/or continuous. For example, discretely defined translucency values 317 can include one or more discrete intermediate translucency levels, such as high translucency (33%), half translucency (%50), low translucency (66.6%). In contrast, continuous intermediate translucency values 317 can include numerous intermediate values between the maximum and minimum.

The translucency component 314 determines the translucency value 317 based on the progression input of a particular e-book that the user is deemed to be reading. In one implementation, the translucency value 317 as determined by the translucency component 314 is inversely related to the progress of the user in reading the e-book. For example, the less progress the user has made in reading the e-book, the more translucent the graphic representation of the e-book appears when displayed by library view component 312. Likewise, the closer the user is to completing the e-book, the more opaque (or less translucent) the graphic representation of the e-book appears when displayed by the library view component 312.

Still further, some embodiments provide for the translucency component 314 to specify and implement translucency on portions of the graphic representation of an e-book that is being read. For example, as shown with an example of FIG. 5C, the translucency component 314 can generate a translucency value that specifies regions, or discrete portions of the graphic representation of an e-book for a designated translucency value. The result is that a portion of an e-book icon, for example, can appear translucent, while another portion can appear without translucency. The portion of the e-book book cover that appears translucent can directly relate to an amount of progress that user makes in completing the e-book.

The separation of translucent and non-translucent portions can follow various formats. For example, a linear format may be followed in which the graphic representation of the e-book (e.g., icon) initially appears translucent (e.g., 85% translucency), but as a user progresses through the e-book, the graphic representation becomes non-translucent from left to right. The point of non-translucency can coincide with a measure of the user's progression in reading the e-book. Thus, for example, if the user completes half of an e-book, a left half of the graphic representation (e.g., icon) can appear non-translucent, and the right half of the e-book graphic representation can appear translucent (e.g., 85% translucent).

Other formats may designate other patterns for displaying translucency/non-translucency. An example such as described can serve as a variation to alter the level of translucency for an entire icon or image of an e-book. For example, in one implementation, the level of translucency can be static, but the number of pixels that appear translucent can vary based on the user's progression in reading the e-book.

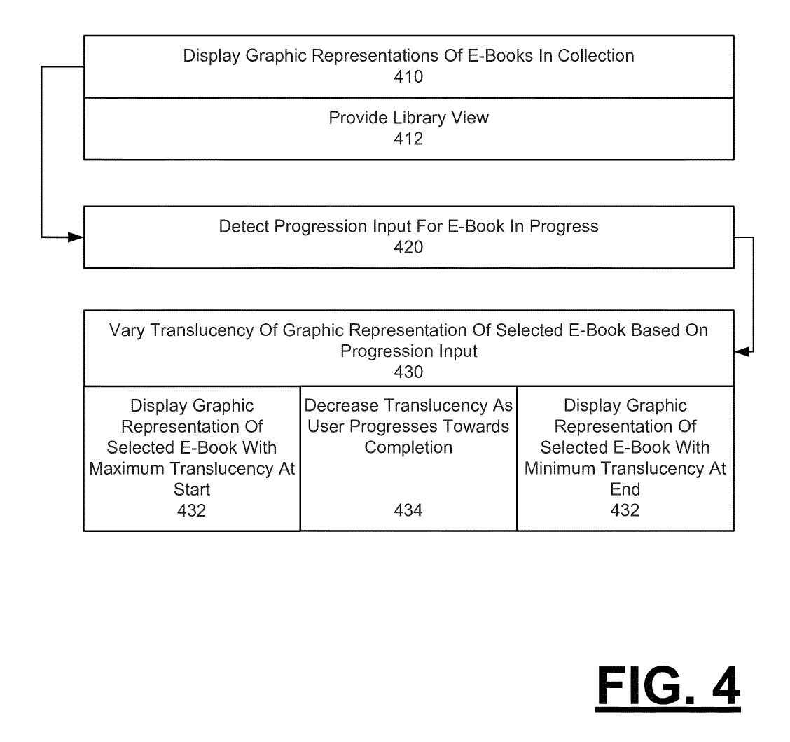

FIG. 4 illustrates a method for displaying translucency with graphic representations of e-books, according to one or more embodiments. A method such as described by an example of FIG. 4 may be implemented using components such as described with an example of FIG. 1, FIG. 2 or FIG. 3. Accordingly, reference is made to elements of other figures for purpose of illustrating an example of a suitable component for performing a step or sub-step described.

With reference to FIG. 4, a computing device (e.g., e-reader device 110) can display graphic representations of e-books belonging to a user's collection in multiple environments and context (410). One such context described includes a library presentation view, which provides for displaying e-books belonging to the user collection in any one of a variety of formats (e.g., list view, folder view, panel view, bookshelf or bookcase view, etc.) (412).

The user's progress in reading an e-book is detected and monitored (420). In one implementation, the progress of the user can be monitored based on the page that the user last completes before ending a reading session. For example, the usage monitor 324 can detect the user's location within the e-book on an ongoing basis, and then record the location (e.g., page) when the user ends the reading session. The end of the reading session can be signified by, for example, the user closing the e-book, returning to the library view, opening another application not related to reading a particular e-book, or switching the device into an off-state. In some variations, the user's progress can be tracked across multiple devices that are linked to the user's account via the network service 120. For example, when the user initiates reading of a particular e-book on the user's device, the memory management module 320 can check memory 330 to determine the progression input 345 for the particular e-book. This can correspond to the last page the user viewed before ending the prior reading session. Additionally, the service interface 340 can communicate with the network service 120 to receive progression input 345 from the network service 120. The progression input 345 from memory 330 can be compared to that received from the network service 120 to determine which progression was further, or which progression was more recent.

A translucency for the graphic representation of the e-book being read can be varied based on the determined progression input for that e-book (430). The context for displaying the graphic representation of a given e-book with translucency can include providing a library presentation in which multiple e-books in the user collection are displayed at one time. A translucency component 314 can be implemented to affect the translucency of individual pixels that comprise the graphic representation of a given e-book. According to some embodiments, a translucency level affecting all (or substantially all) of the pixels that comprise the graphic representation of the e-book can be varied to implement a translucency level that is determined by the translucency component 314. As noted with some other examples, the translucency level can be inversely related to the progression input, so that the graphic representation of the e-book becomes less translucent as the user advances in reading the e-book. In one implementation, the graphic representation of the e-book can be displayed with maximum translucency (e.g. 60-80% translucent) upon the user initiating reading of the book. For example, the graphic representation of the given e-book can be non-translucent when first purchased and downloaded from the network service 120. Once the user opens the given e-book, the graphic representation of the e-book can have its translucency level determined by the user's progress in completing the e-book. In some variations, if the user's progress is less than a designated threshold (e.g. less than 5% of completion, or less than five pages, etc.) then the graphic representation can be displayed with maximum translucency (432). Subsequently, the translucency can decrease as a user progresses through the e-book (434). The change in translucency can be discreet, so as to be at designated levels, corresponding to a range of the user's progress. Alternatively, the change in translucency can be continuous. For example, the translucency level can be inversely proportionate to a measure of the e-book remaining for the user to complete, such as the percentage of the e-book remaining for the user, or the amount of time left for the user to complete the e-book. The e-book can be displayed with minimum translucency when the user's completion exceeds a designated criteria or threshold. For example, the e-book can be displayed with minimum translucency when the user is deemed to complete the e-book, or when the user is deemed to complete a substantial portion (e.g., 90%) of the e-book. Minimum translucency can correspond to no translucency, or alternatively to a small measure of translucency (e.g., 5 or 10% translucent).

As an alternative or variation to varying the translucency level of a graphic representation in its entirety, the translucency of the graphic representation can be varied for only a discrete portion of the representation. The discrete portion of the graphic representation can be varied to reflect the portion of the identified e-book that the user has yet to complete. For example, if the user completes 50% of a given e-book, then one implementation provides that a discrete portion corresponding to 50% of the graphic representation is provided in translucent form, and the other 50% is provided in non-translucent form. Various formats can be used to display discrete portions of the graphic representation in translucent form, so as to qualitatively convey information, such as the portion of the e-book that the user has completed reading.

### EXAMPLES

FIG. 5A illustrates an example of a library presentation that implements translucency with the graphic representation of one or more e-books, in order to convey a user's progress level in reading a corresponding e-book. In the example shown, the graphic representation of an e-book can include an icon with imagery corresponding to a digital book cover or jacket. The library presentation 500 can provide a panel view of icons representing e-books in the user's collection. In the specific example provided, the library presentation 500 represents a home view, corresponding to an initial panel from which the user can view an e-book collection. An icon 512 can correspond to an archived e-book, where the archived e-book resides with the network service 120 and is associated with the user's account. A second icon 514 can represent an e-book that the user has recently purchased or downloaded, but has yet to open or initiate reading. Still further, one or more third icons 516 can correspond to e-books that the user has completed reading, or substantially completed reading.

A fourth icon 520 can representing an e-book that is being read but not completed. In the example provided, the fourth icon 520 can be provided in translucent form, to convey the percentage of the e-book that the user has completed reading. For example, the fourth icon 520 is shown as being 15% read, and a translucency level of the graphic representation at or near a maximum level.

Additionally, in the example provided, the panel displays textual or alternative progress information with individual icons that the user has initiated reading, but has yet to complete. For example, the panel displays textually a percentage of the e-book that the user has read. Alternatively, the panel can include percentage bars or other graphic representations that are displayed separately from the graphic representation of the e-book (e.g., the iconic display a book cover). However, it will be appreciated that an example such as provided reduces or eliminates a need to display separately textual or non-textual representations of the user's progress in reading the particular e-book. Rather, examples described herein provide that the user's progress can be conveyed by the translucency of the e-book, with feint (or translucent) icons representing e-books that the user has considerable amount of reading left to do, and darkened or non-translucent icons representing those e-books of the user has completed or nearly completed reading.

In one implementation, the icon 516 for the completed e-book is represented in non-translucent fashion. Similarly, the substantially completed e-book, represented by icon 522 can also be represented in non-translucent fashion. In the latter case, examples recognize that the latter portion of the e-book is sometimes dedicated to pages that users do not read (e.g., an author's note, a preview for another story), and that the user may have in fact completed an e-book when the progress input reflects the user has only substantially completed the book. Accordingly, some embodiments provide that a threshold is met when the user completes a substantial portion of the e-book (e.g., 90% or 95%). When the threshold is met, the translucency level may be said to be at a minimum (e.g., no translucency).

Still further, the icon 512 representing the newly purchased e-book (which the user has not initiated reading) can be provided in non-translucent form. The icon 520 representing the e-book book that the user is in progress in reading is provided in translucent form. Specifically, the level of translucency is inversely proportional to the progress of the user in completing the e-book. In the example provided, the icon 520 appears heavily translucent to reflect that the user has just started e-the book.

FIG. 5B illustrates an alternative panel view 530 for displaying the contents of the user's e-book collection. In an example provided, the panel view 530 displays the e-books that the user has recently read, including those e-books that are in progress. The icon 532 for the in progress e-book is displayed with translucency, while those that have been completed are non-translucent.

FIG. 5C illustrates an alternative list view 540 for displaying the contents of the user's e-book collection. The list view 540 provides an example of an interface in which metadata associated with the particular e-book of the user's collection is displayed. In the list view 540, individual entries include the graphic representation 542 and text descriptors 544. The text descriptors 544 can include the title, author, and summary and other status information. In the example provided, the graphic representation 542 for an e-book that the user is reading (but has not completed) is shown with translucency, reflecting the progress of the user in reading the e-book.

FIG. 5D illustrates an alternative implementation in which a discrete portion of the graphic representation of an e-book is made translucent to reflect the progress of the user in reading the e-book. In an example of FIG. 5D, a partially translucent graphic representation 550 includes a non-translucent portion 552 and a translucent portion 554. A boundary 555 separating the two portions can progress in a linear direction, such as from left to right. The progression of the boundary 555 can coincide with the user's progress in reading the underlying e-book.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for operating a computing device, the method being implemented by one or more processors and comprising:
displaying a set of graphic representations, each graphic representation representing a corresponding e-book in a collection of e-books;
detecting a user's progress in reading a first e-book in the collection, the first e-book represented by a first graphic representation in the set of graphic representation; and
wherein displaying the set of graphic representations includes varying a translucency of the first graphic representation based on the detected progress of the user in reading the first e-book.

2. The method of claim 1, wherein displaying the set of graphic representations includes displaying a library view of collection of e-books.

3. The method of claim 1, wherein varying the translucency of the first graphic representation includes varying a level of the translucency of the first graphic representation based on a portion of the first e-book that the user has read.

4. The method of claim 3, wherein varying the level of the translucency of the first graphic representation includes displaying the first graphic representation with a maximum level of translucency when the user initiates reading the first e-book without completing a portion that exceeds a minimum threshold.

5. The method of claim 3, wherein varying the level of the translucency includes reducing the translucency of the first graphic representation as the user progresses in reading the e-book.

6. The method of claim 5, wherein reducing the translucency of the first graphic representation includes displaying the first graphic representation as part of the collection with a maximum level of translucency when the detected user's progress is below a minimal threshold, and increasing the level of translucency to one or more intermediate levels as the user is detected to progress towards completing the e-book.

7. The method of claim 5, wherein reducing the translucency of the first graphic representation includes displaying the first graphic representation without translucency upon detecting the user completing a portion of the e-book that exceeds a maximum threshold.

8. The method of claim 1, wherein each e-book of the collection includes one of an electronic magazine or an electronic comic book.

9. The method of claim 1, wherein each graphic representation in the set of graphic representations includes an icon rendition of a book cover.

10. The method of claim 1, wherein varying the translucency of the first graphic representation includes rendering only a portion of the first graphic representation in a translucent format, the portion being based on the detected user's progress in reading the first e-book.

11. The method of claim 10, wherein varying the translucency of the first graphic representation includes decreasing the portion of the first graphic representation in the translucent format as the detected user's progress moves towards completion.

12. A non-transitory computer-readable medium to store instructions, that when executed by one or more processors, cause the one or more processors to perform operations that include:
displaying a set of graphic representations, each graphic representation representing a corresponding e-book in a collection of e-books;
detecting a user's progress in reading a first e-book in the collection, the first e-book represented by a first graphic representation in the set of graphic representation;
wherein displaying the set of graphic representations includes varying a translucency of the first graphic representation based on the detected progress of the user in reading the first e-book.

13. The computer-readable medium of claim 12, wherein instructions for displaying the set of graphic representations includes instructions for displaying a library view of collection of e-books.

14. The computer-readable medium of claim 12, wherein instructions for varying the translucency of the first graphic representation includes instructions for varying a level of the translucency of the first graphic representation based on a portion of the first e-book that the user has read.

15. The computer-readable medium of claim 14, wherein instructions for varying the level of the translucency of the first graphic representation includes instructions for displaying the first graphic representation with a maximum level of translucency when the user initiates reading the first e-book without completing a portion that exceeds a minimum threshold.

16. The computer-readable medium of claim 14, wherein instructions for varying the level of the translucency includes instructions for reducing the translucency of the first graphic representation as the user progresses in reading the e-book.

17. The computer-readable medium of claim 16, wherein instructions for reducing the translucency of the first graphic representation includes instructions for (i) displaying the first graphic representation as part of the collection with a maximum level of translucency when the detected user's progress is below a minimal threshold, and (ii) increasing the level of translucency to one or more intermediate levels as the user is detected to progress towards completing the e-book.

18. The computer-readable medium of claim 16, wherein instructions for reducing the translucency of the first graphic representation includes instructions for displaying the first graphic representation without translucency upon detecting the user completing a portion of the e-book that exceeds a maximum threshold.

19. The computer-readable medium of claim 12, wherein each e-book of the collection includes one of an electronic magazine or an electronic comic book.

20. A computer system comprising:
a memory resource that stores a set of instructions;
one or more processors that use the set of instructions to:
display a set of graphic representations, each graphic representation representing a corresponding e-book in a collection of e-books;
detect a user's progress in reading a first e-book in the collection, the first e-book represented by a first graphic representation in the set of graphic representation;
wherein one or more processors display the set of graphic representations by varying a translucency of the first graphic representation based on the detected progress of the user in reading the first e-book.
